(19) United States
(12) Patent Application Publication
(10) Pub. No.: US 2007/0153423 A1
(43) Pub. Date: Jul. 5, 2007

(54) Substrate material for an hdd suspension

(76) Inventors: Hiromasa Shoji, Chiba (JP); Yuji Kubo, Chiba (JP); Takeshi Hamada, Chiba (JP); Tamami Mizuno, Chiba (JP); Kazuto Okamura, Chiba (JP); Tazo Sawamura, Chiba (JP)

Correspondence Address: KENYON & KENYON LLP, ONE BROADWAY, NEW YORK, NY, 10004, US

(21) Appl. No.: 10/585,181

(22) PCT Filed: Dec. 28, 2004
(86) PCT No.: PCT/JP04/19836

§ 371 Date: Jun. 29, 2006

(30) Foreign Application Priority Data
Jan. 5, 2004 (JP) 2004-000475

(51) Int. Cl. G11B 5/48; G11B 21/16

(52) U.S. Cl. 360/244.3

(57) ABSTRACT

There is provided a substrate material, for an HDD suspension, which has excellent adhesion between a stainless steel foil and an insulating resin layer and maintains high etching performance by preventing metal components in the stainless steel from diffusing into the insulating resin layer. The substrate material for an HDD suspension of the invention is a material obtained by shaping a stainless steel foil, wherein, on the surface of the stainless steel foil and on at least one side thereof, there are laminated, at least, a covering layer made chiefly of either one or both of a metal oxide and a metal hydroxide with chromium excluded as the metal species, and an insulating resin layer.

### TECHNICAL FIELD

The present invention relates to a substrate material, for an HDD suspension, having excellent adhesion to an insulating resin layer.

### BACKGROUND ART

Production of hard disk drives (hereinafter abbreviated as HDDs) has increased in recent years due to the widespread use of personal computers and newly developed applications in household appliances and car navigation systems. It is expected that HDDs having increased capacities and decreased sizes will be produced in the future. Also, concerning a suspension portion (hereinafter referred to as HDD suspension) that constitutes a flexure blank for magnetic reading in the HDD, it is considered that attempts will be made to decrease the size, to increase the number of wires and to decrease the wire sizes.

A wireless suspension is a three-ply member comprising a metal layer (conducting layer)/an insulating resin layer/a metal layer (support layer), in which copper wiring is directly formed on a leaf spring, made of stainless steel foil, used as the support layer with an insulating layer being sandwiched therebetween. This member receives small vibration and an inertial force at the time of scanning a disk that rotates at a high speed. Therefore, adhesion is indispensable between the metal layer and the insulating layer. A further improved adhesion is required as the size of the member decreases and as the size of the wiring becomes finer.

The insulating resin layers that constitute the laminate are shaped by a wet-etching method or a dry-etching method. However, the modification of resin due to the diffusion of a metal component from the metal layer into the insulating resin layer causes a problem of a great decrease in the etching rate. Among the shaping methods, in particular, the drying-etching method, based on the widely employed plasma method, has a high running cost and, hence, a high working cost, and is subject to serious problems if the etching rate decreases.

Under such circumstances, JP 2001-207194 A reports a method of producing a rolled stainless steel foil material having excellent adhesion to a polyimide resin, characterized by effecting washing, after rolling, with an aqueous solution having a fluoride ion concentration of 0.5 to 3 mols/m³ and a pH of 2 to 4.2. It has been mentioned that the above technology makes it possible to efficiently remove the rolling oil remaining on the surface of the rolled material and a hydrophobic film formed in the atmosphere through a chemical treatment, to decrease the defectively adhered portion and to maintain adhesion between the stainless steel foil and the polyimide resin. In fact, however, the adhesion is not sufficient and, besides, the effect for suppressing the diffusion of a metal component cannot be expected.

As described above, there has not yet been developed a method, of treating the surfaces of a stainless steel foil, which provides adhesion to the insulating layer and is effective in suppressing the diffusion of metal components. Therefore, an effective method is needed as early as possible.

### DISCLOSURE OF THE INVENTION

The present invention was accomplished in view of the above circumstances and has an object of providing a substrate material for an HDD suspension, which provides excellent adhesion between a stainless steel foil and an insulating resin layer, and maintains high etching-rate performance by preventing metal components in the stainless steel from diffusing into the insulating resin layer.

In order to solve the above problem, the present inventors have conducted a study and have discovered that excellent adhesion is exhibited between a stainless steel foil and an insulating resin layer when there is provided a substrate material, for an HDD suspension, by laminating, on the surface of the stainless steel foil and on at least one side thereof, at least a covering layer made chiefly of either one or both of a metal oxide and metal hydroxide, with chromium excluded as the metal species, and an insulating resin layer and that, in this case, the rate of etching the insulating resin does not decrease despite the use of a widely used etchant, and have thus arrived at the present invention.

The present invention is as described below.

(1) A substrate material for an HDD suspension obtained by shaping a stainless steel foil, wherein, on the surface of the stainless steel foil and on at least one side thereof, there are laminated, at least, a covering layer made chiefly of either one or both of a metal oxide and a metal hydroxide with chromium excluded as the metal species, and an insulating resin layer.

(2) A substrate material for an HDD suspension as described in (1) above, wherein the covering layer has an average thickness of not larger than 5 μm.

(3) A substrate material for an HDD suspension as described in (1) or (2) above, wherein the covering layer covers the stainless steel foil at a covering ratio of not less than 10%.

(4) A substrate material for an HDD suspension as described in any one of (1) to (3) above, wherein the covering layer is distributed like islands on the stainless steel foil.

(5) A substrate material for an HDD suspension as described in any one of (1) to (4) above, wherein cracks are present in the covering layer.

(6) A substrate material for an HDD suspension as described in (1) above, wherein the metal species is one or more selected from zirconium, titanium and silicon.

(7) A substrate material for an HDD suspension as described in (1) above, wherein the metal species is titanium.

(8) A substrate material for an HDD suspension as described in (1) above, wherein the adhering force between the stainless steel foil having the covering layer and the insulating resin layer is not smaller than 0.54 kN/m.

(9) A substrate material for an HDD suspension as described in (1) above, wherein the stainless steel foil has a thickness of 10 to 100 μm.

(10) A substrate material for an HDD suspension as described in (1) above, wherein the insulating resin layer has a thickness of 1 to 150 μm.

(11) A substrate material for an HDD suspension as described in (1) above, wherein the insulating resin layer is a heat-resistant polyimide resin.

(12) A substrate material for an HDD suspension as described in (11) above, wherein the heat-resistant polyimide resin layer has a three-ply structure of a high thermal expansion polyimide/a low thermal expansion polyimide/a high thermal expansion polyimide.

(13) A substrate material for an HDD suspension as described in (12) above, wherein the heat-resistant polyimide resin layer has a coefficient of linear expansion in a range of 1×10⁻⁵ to 3×10⁻⁵/° C.

(14) A substrate material for an HDD suspension as described in (1) above, wherein a metal layer is further laminated on the insulating resin layer.

(15) A substrate material for an HDD suspension as described in (14) above, wherein the metal layer is a metal foil.

(16) A substrate material for an HDD suspension as described in (15) above, wherein the metal foil is a surface-treated metal foil.

(17) A substrate material for an HDD suspension as described in (15) or (16) above, wherein the metal foil is a stainless steel foil or a copper foil.

(18) A substrate material for an HDD suspension as described in (14) above, wherein the adhering force between the metal layer and the insulating resin layer is not smaller than 0.54 kN/m.

(19) A substrate material for an HDD suspension as described in any one of (1) to (18) above, which is a substrate material for a load beam that constitutes the HDD suspension.

(20) A substrate material for an HDD suspension as described in any one of (1) to (18) above, which is a substrate material for a flexure blank that constitutes the HDD suspension.

According to the present invention, there can be provided a substrate material for an HDD suspension having excellent adhesion between a stainless steel foil and an insulating resin layer. Further, the yield and the stability of quality are improved in shaping the substrate material into an HDD suspension material such as a load beam or a flexure blank.

### BEST MODE FOR CARRYING OUT THE INVENTION

The invention will be described below in detail.

This invention is a substrate material for an HDD suspension, obtained by shaping a stainless steel foil, wherein, on the surface of the stainless steel foil and on at least one side thereof, there are laminated, at least, a covering layer made chiefly of either one or both of a metal oxide and a metal hydroxide with chromium excluded as the metal species, and an insulating resin layer.

Through keen study, the present inventors have discovered that, when a covering layer made chiefly of either one or both of a metal oxide and a metal hydroxide is formed on the surface of a stainless steel foil, the adhesion thereof to the insulating resin is improved as compared to when the above treatment is not effected. Though the mechanism has not been clarified, it is considered to be caused by the fact that the metal oxide and the metal hydroxide possess a firm chemical bond with the insulating resin formed thereon. A further improved adhesion was discovered when the covering layer made chiefly of either one or both of the metal oxide and the metal hydroxide has a covering ratio of not smaller than 10%. Though the mechanism is also not clear, it is considered that the improvement might have been resulted from an action resembling the so-called anchoring effect. Here, the covering ratio stands for a ratio of the area of the covering layer to the surface area of the stainless steel foil. The states concerned include a case where the covering layer deposits like islands which often happen when the amount of the material for forming film is small, a case where the amount of the material for forming film is sufficient but cracks are present therein reaching the underlayer, and a case where cracks are present in the portions deposited like islands. In these cases, it is considered that the anchoring effect is exhibited due to an increased surface area and due to the resin biting into the cracks, and an increased area that takes part in the chemical bond, leading to the improved adhesion. These effects are not exhibited to a sufficient degree when the covering ratio is smaller than 10%. It was further confirmed that a drop in the rate of etching the insulating resin was suppressed when the covering ratio of the covering layer was not smaller than 10%. This is presumably due to suppressed diffusion of metal components from the substrate material.

It is desired that the covering layer made chiefly of either one or both of the metal oxide and the metal hydroxide has an average thickness of not larger than 5 μm. When the thickness exceeds 5 μm, the adhesion saturates, which is not economical, and, in some cases performance of the substrate material may be deteriorated. The lower limit of average thickness is such that, even if there is an uncovered portion, the thickness of the covered portion is at least that of a single molecule layer.

It is desired that the insulating resin layer that is to be laminated has a thickness of 1 to 150 μm. When the thickness is smaller than 1 μm, reliability in the electric insulation decreases and, at the same time, the dielectric properties may be deteriorated. When the thickness exceeds 150 μm, it becomes difficult to effect patterning while maintaining a high precision. More desirably, the insulating resin layer to be laminated has a thickness of 3 to 20 μm.

There is no particular limitation on the metal specifies of the metal oxide or the metal hydroxide formed on the stainless steel foil of the present invention except that chromium is excluded. The metal species include iron, magnesium, niobium, tantalum, aluminum, nickel, cobalt, titanium, zirconium, silicon and the like. The covering layer may be constituted by using one of the metal species, a composite system or a mixed system of two or more metal species, or even by lamination. Particularly preferred metals are titanium, zirconium and silicon because it is considered that the oxides and hydroxides of titanium, zirconium and silicon can form a favorable bond with an organic matter. The oxide and hydroxide of chromium have also been confirmed for their effect of adhesion. However, chromium was excluded from the metal species by taking into consideration the environmental load that is affected by chromium ions that may be formed at the time of forming the film and chromium ions that may remain in the film. There is no particular limitation on the method of forming either one or both of the metal oxide and the metal hydroxide on the stainless steel foil, and a widely known method can be employed. For example, there can be employed a liquid phase method, such as a liquid phase deposition method that uses fluoride ions, such as fluorocomplex ions of a metal, or a sol-gel method, and a dry method such as a sputtering or CVD method.

Though there is no particular limitation on controlling the covering ratio of the metal oxide or the metal hydroxide formed on the surface of the metal plate or on the method of forming cracks, there can be exemplified a mechanical grinding by using a polishing paper, a heat shock such as quenching, or chemical etching using an acidic aqueous solution, an alkali aqueous solution or an aqueous solution containing fluoride ions. Cracks may develop by themselves depending upon the method of forming a film or the conditions for forming a film.

Though there is no particular limitation on the stainless steel foil that can be used in the present invention, it is desired to use SUS 304 from the standpoint of spring characteristics and dimensional stability. A preferred thickness of the stainless steel foil is in a range of 10 to 100 μm. When the thickness is smaller than 10 μm, the laminate warps so greatly that the substrate material for the HDD suspension loses reliability as a support member. When the thickness is greater than 100 μm, the rigidity becomes too great to be used as a substrate material for HDD suspension.

There is no particular limitation on the kind of the insulating resin of the present invention. For example, there can be used polyimide, polyethylene, phenol resin, unsaturated polyester resin, fluororesin, or the like. By taking the heat resistance, flame retarding property, dimensional stability and chemical resistance into consideration, it is desired to use a polyimide-based resin comprising a polymer having an imide bond in the structure such as polyimide, polyamideimide or polyetherimide in the structure. There is no limitation on the kind of the polyimide resin, as a matter of course. There is also no limitation on the method of laminating the insulating resin layer. There is no limitation on the structure of the resin layer, which may be a single layer or a multiplicity of layers of a plurality of kinds of polyimides. Desirably, however, the resin layer has a three-ply structure of a high thermal expansion polyimide resin layer/a low thermal expansion polyimide resin layer/a high thermal expansion polyimide resin layer using a high thermal expansion polyimide as the polyimide-based resin of the layer that comes in contact with the stainless steel foil or the metal layer (hereinafter, adhesion layer) and a low thermal expansion polyimide as the polyimide-based resin of the layer that does not come in contact with the stainless steel foil or the metal layer (hereinafter, core layer). The reason for this is that the adhesion layer must possess plasticity when heated to promote chemical bond to the stainless steel foil or the metal layer and to produce an adhering force based on the anchoring effect while the core layer must be resistant to thermal expansion to suppress a dimensional change of the resin layer and warping after the working. Here, the kinds of resins of the two adhesion layers may be the same or different. There is no limitation on the thickness of the three layers. The covering layer made chiefly of either one or both of the metal oxide and the metal hydroxide may assume a shape that is deposited as islands or that contains cracks reaching the underlayer. Here, however, it is desired that the adhesion layer has a thickness which is not smaller than a difference in the height in the above shape from the standpoint of obtaining adhesion stemming from the resin that is biting to a sufficient degree. However, the resin of the adhesion layer is a high thermal expansion resin creating a factor for increasing a dimensional change of the polyimide resin, and therefore should not be too thick. It is desired that the coefficient of linear expansion of the three layers is 1×10⁻⁵ to 3×10⁻⁵/° C. Upon combining the low thermal expansion polyimide resin layer and the high thermal expansion polyimide resin layers together to form the polyimide resin layer of a multi-layer structure, it becomes possible to form a resin layer that satisfies both a low thermal expansion property, and high degree of adhesion, as material properties.

As required, further, a metal layer may be further laminated on the insulating resin layer. There is no particular limitation on the metal layer laminated on the insulating resin layer, and as a material therefor, there can be exemplified copper, a copper alloy, aluminum and an aluminum alloy. If it is a metal foil, it may be exemplified by a stainless steel foil, a copper foil, a copper alloy foil, an aluminum foil and an aluminum alloy foil. The metal foil may be chemically or mechanically treated on their surfaces in order to improve the adhering force and the like.

It is desired that the adhering force between the stainless steel foil or the metal layer having the covering layer and the insulating resin layer is not smaller than 0.54 kN/m. When the adhering force is smaller than 0.54 kN/m, exfoliation may occur during the treatment, such as etching, for the production of a substrate material for an HDD suspension. Further, in an environment in which the substrate material for the HDD suspension is used, inconvenience tends to occur due to small vibration and an inertial force at the time of scanning a disk that rotates at high speed.

There is also no particular limitation on working the substrate material into a member for constituting an HDD suspension such as a load beam or a flexure. The material can be worked by, for example, etching a metal portion or an insulating resin layer portion.

### EXAMPLES

The present invention will now be specifically described by way of Examples which, however, are in no way intended to limit the invention.

[Metal Materials]

Stainless steel foils (SUS 304) of various thicknesses were used as substrate materials. As required, further, there were used an aluminum foil and a copper foil.

[Method of Forming a Covering Layer on the Substrate Material]

A metal oxide and a metal hydroxide were deposited to the substrate materials by a liquid-phase deposition method or a sputtering method. As a treating liquid for the liquid-phase precipitation method, there was used (1) a 0.1 mol/L aqueous ammonium hexafluorosilicate solution, (2) a 0.1 mol/L aqueous ammonium hexafluorotitanate solution, or (3) a 0.1 mol/L aqueous ammonium hexafluorozirconate solution. A metal oxide and a metal hydroxide were formed on the stainless steel foils, by cathodic electrolysis, by immersing a stainless steel foil in the above treating solution and by using aluminum as a counter electrode. The film-forming conditions consisted of a current density that was controlled to be 100 mA/cm² and electrolyzing at room temperature for 1 to 10 minutes. The film that was formed was washed with water and dried.

In case of a sputtering method, a metal oxide was formed on the metal substrate using Si, Ti or Zr as a target.

Formation of the metal oxide and metal hydroxide in the formed covering layer was confirmed by X-ray photoelectron spectroscopy and infrared-ray spectroscopy.

[Insulating Resins]

Insulating resins were prepared by using the following polyimide precursor solutions.

First, 3690.0 g of N,N-dimethylacetamide was dissolved while stirring 292.3 g (1 mol) of 1,3-bis(4-aminophenoxy)benzene in a 5-L separable flask. 358.3 g (1 mol) of 3,3′,4,4′-diphenylsulfonetetracarboxylic dianhydride was added to the solution in a nitrogen stream while cooling the solution in an ice bath. The solution was returned to room temperature and was polymerized for 3 hours with stirring to obtain a polyimide precursor solution A.

Next, 2560.0 g of N,N-dimethylacetamide was dissolved while stirring 154.4 g (0.6 mols) of 4,4′-diamino-2′-methoxybenzanilide and 80.1 g (0.4 mols) of a 4,4′-diaminodiphenyl ether in a 5-L separable flask. 218.1 g (1 mol) of pyromellitic dianhydride was added to the solution in a nitrogen stream while cooling the solution in an ice bath. The solution was returned to room temperature and was polymerized for 3 hours with stirring to obtain a polyimide precursor solution B.

Further, 3530.0 g of N,N-dimethylacetamide was dissolved while stirring 292.3 g (1 mol) of 1,3-bis(4-aminophenoxy)benzene in a 5-L separable flask. 286.6 g (0.8 mols) of 3,3′,4,4′-diphenylsulfonetetracarboxylic dianhydride and 43.6 g (0.2 mols) of pyromellitic dianhydride were added to the solution in a nitrogen stream while cooling the solution in an ice bath. The solution was returned to room temperature and was polymerized for 3 hours with stirring to obtain a polyimide precursor solution C.

[Methods for Evaluating the Prepared Samples]

(1) Evaluation of Adhesion

Adhesion of a target interface was evaluated by preparing a measuring sample by forming a linear pattern of a width of 3.2 mm on the metal material that constitutes the target interface, thereafter sticking the sample on the side of the polyimide resin onto a fixing plate, and peeling the metal material constituting the target interface in a direction of 90 degrees in a manner that peeling occurs only at the target interface by using a tension tester (Strograph-MI, manufactured by Toyo Seiki Co.) to measure the adhering force. The measured adhering force was evaluated to be A when it was not smaller than 0.54 kN/m and B when it was smaller than 0.54 kN/m.

(2) Measurement of Covering Ratio of the Covering Layer

The covering ratio of the covering layer formed on the substrate material was found in a manner as described below. The substrate material was observed by using a scanning electron microscope of a magnification of 10,000 times, and the image thereof was treated to distinguish the metal substrate and the covering layer to thereby find a ratio thereof. The observation was conducted at five arbitrary places, and an average value thereof was regarded to be the covering ratio.

(3) Evaluation of Etching Performance

Etching performance of the polyimide resin layer formed on the stainless steel foil was evaluated. The samples were immersed in a 100% hydrated hydrazine at 50° C. to compare the rates of etching for the polyimide resin layers. The etching rate for the polyimide resin layer formed on the non-treated stainless steel foil was regarded to be a reference, and a rate larger than the reference was evaluated to be A, a rate equal to the reference was evaluated to be B, and a rate smaller than the reference was evaluated to be C.

### Example 1

Various kinds of covering layers were formed on stainless steel foils of 10 μm thick under the conditions shown in Table 1. There was also used a non-treated stainless steel foil as a comparative material.

Next, polyimide resin layers of various thicknesses were formed on the surfaces of these samples. When the resin layer having a total thickness of 10 μm was to be formed, the above-mentioned polyimide precursor solution A was applied onto the surface of the sample such that the film thickness after cured was 1 μm, followed by drying at 130° C. for 4 minutes. Next, the above-mentioned polyimide precursor solution B was applied thereon such that the total thickness of the two layers after cured was 9 μm, followed by drying at 130° C. for 8 minutes. Further, the above-mentioned polyimide precursor solution C was applied thereon such that the total thickness of the three layers after cured was 10 μm, followed by drying at 130° C. for 4 minutes. The sample on which the three polyimide resin layers were laminated as described above was heat-treated in a nitrogen stream under such a condition that a maximum temperature that was reached was 360° C. to thereby finish the curing of the resin layers.

The thus obtained samples were tested and evaluated as described above. The results are shown in Table 1.

TABLE 1

| | | | | | | | Insulating | | | |
|---|---|---|---|---|---|---|---|---|---|---|
| | Treatment of stainless steel foil (SUS304, 10 μm) | | | | | | resin | Evaluation | | |
| | | | | | | Film | Film | result | | |
| | | Treating | Oxide | Covering | | thickness/ | thickness/ | | Etching | |
| No. | Film forming method | Solution | species | ratio/% | State of film | μm | μm | Adhesion | rate | Remarks |
| 1 | Liquid phase deposition | (1) | SiO₂ | 100 | — | 5 | 10 | A | A | Example |
| 2 | Liquid phase deposition | (1) | SiO₂ | 100 | — | 4 | 10 | A | A | Example |
| 3 | Liquid phase deposition | (1) | SiO₂ | 100 | — | 3 | 10 | A | A | Example |
| 4 | Liquid phase deposition | (1) | SiO₂ | 100 | — | 2 | 10 | A | A | Example |
| 5 | Liquid phase deposition | (1) | SiO₂ | 100 | — | 1 | 10 | A | A | Example |
| 6 | Liquid phase deposition | (1) | SiO₂ | 100 | — | 0.5 | 10 | A | A | Example |
| 7 | Liquid phase deposition | (2) | TiO₂ | 100 | — | 0.5 | 10 | A | A | Example |
| 8 | Liquid phase deposition | (2) | TiO₂ | 90 | Crack | 0.5 | 10 | A | A | Example |
| 9 | Liquid phase deposition | (2) | TiO₂ | 80 | Crack | 0.5 | 10 | A | A | Example |
| 10 | Liquid phase deposition | (2) | TiO₂ | 70 | Crack | 0.5 | 10 | A | A | Example |
| 11 | Liquid phase deposition | (2) | TiO₂ | 60 | Island, crack | 0.5 | 10 | A | A | Example |
| 12 | Liquid phase deposition | (2) | TiO₂ | 50 | Island, crack | 0.5 | 10 | A | A | Example |
| 13 | Liquid phase deposition | (2) | TiO₂ | 40 | Island, crack | 0.5 | 10 | A | A | Example |
| 14 | Liquid phase deposition | (2) | TiO₂ | 30 | Island | 0.5 | 10 | A | A | Example |
| 15 | Liquid phase deposition | (2) | TiO₂ | 20 | Island | 0.5 | 10 | A | A | Example |
| 16 | Liquid phase deposition | (2) | TiO₂ | 10 | Island | 0.5 | 10 | A | A | Example |
| 17 | Liquid phase deposition | (3) | ZrO₂ | 70 | Crack | 0.5 | 0.5 | A | A | Example |
| 18 | Liquid phase deposition | (3) | ZrO₂ | 70 | Crack | 0.5 | 1 | A | A | Example |
| 19 | Liquid phase deposition | (3) | ZrO₂ | 70 | Crack | 0.5 | 10 | A | A | Example |
| 20 | Liquid phase deposition | (3) | ZrO₂ | 70 | Crack | 0.5 | 30 | A | A | Example |
| 21 | Liquid phase deposition | (3) | ZrO₂ | 70 | Crack | 0.5 | 50 | A | A | Example |
| 22 | Liquid phase deposition | (3) | ZrO₂ | 70 | Crack | 0.5 | 70 | A | A | Example |
| 23 | Liquid phase deposition | (3) | ZrO₂ | 70 | Crack | 0.5 | 90 | A | A | Example |
| 24 | Liquid phase deposition | (3) | ZrO₂ | 70 | Crack | 0.5 | 110 | A | A | Example |
| 25 | Liquid phase deposition | (3) | ZrO₂ | 70 | Crack | 0.5 | 130 | A | A | Example |
| 26 | Liquid phase deposition | (3) | ZrO₂ | 70 | Crack | 0.5 | 150 | A | A | Example |
| 27 | Liquid phase deposition | (3) | ZrO₂ | 70 | Crack | 0.5 | 170 | A | A | Example |
| 28 | Liquid phase deposition | (1) + (2) | SiO₂ + TiO₂ | 70 | Crack | 0.5 | 10 | A | A | Example |
| 29 | Liquid phase deposition | (2) + (3) | TiO₂ + ZrO₂ | 70 | Crack | 0.5 | 10 | A | A | Example |
| 30 | Liquid phase deposition | (1) + (3) | SiO₂ + ZrO₂ | 70 | Crack | 0.5 | 10 | A | A | Example |
| 31 | Sputtering | — | SiO₂ | 100 | — | 0.5 | 10 | A | A | Example |
| 32 | Sputtering | — | TiO₂ | 100 | — | 0.5 | 10 | A | A | Example |
| 33 | Sputtering | — | ZrO₂ | 100 | — | 0.5 | 10 | A | A | Example |
| 34 | Untreated | — | — | | — | — | 10 | B | Reference | Compar- |
| | | | | | | | | | | ative |
| | | | | | | | | | | example |

Irrespective of the method of forming the covering layer, the stainless steel foils having the covering layer formed exhibited excellent adhesion to the insulating resin layer as compared to the non-treated stainless steel foil. Further, the etching performances of the resin layers were equal to, or superior to, that of the case of the non-treated stainless steel foil.

### Example 2

Polyimide resin layers of various thicknesses were formed on the surfaces of copper foils of 10 μm thick. When the resin layer having a total thickness of 10 μm was to be formed, the above-mentioned polyimide precursor solution A was applied onto the surface of the sample such that the film thickness after cured was 1 μm, followed by drying at 130° C. for 4 minutes. Next, the above-mentioned polyimide precursor solution B was applied thereon such that the total thickness of the two layers after cured was 9 μm, followed by drying at 130° C. for 8 minutes. Further, the above-mentioned polyimide precursor solution C was applied thereon such that the total thickness of the three layers after cured was 10 μm, followed by drying at 130° C. for 4 minutes. The sample on which the three polyimide resin layers were laminated as described above was heat-treated in a nitrogen stream under such a condition that a maximum temperature that was reached was 360° C. to thereby finish the curing of the resin layers.

On the other hand, various covering layers were formed on the stainless steel foils of 100 μm thick under the conditions shown in Table 2. There was further prepared a non-treated stainless steel foil as a comparative material.

The resin layers formed on the copper foils were faced to the treated surfaces of the stainless steel foils and were then overlapped thereon, followed by heat-pressing by using a vacuum pressing machine under the conditions of an applied pressure of 100 kg/cm², a temperature of 320° C. and a pressing time of 60 minutes.

The thus obtained samples were tested and evaluated as described above. The results are shown in Table 2.

TABLE 2

| | | | | | | | Insulating | | |
|---|---|---|---|---|---|---|---|---|---|
| | Treatment of stainless steel foil (SUS304, 100 μm) | | | | | | resin | | |
| | | | | | | Film | Film | Evaluation | |
| | Film forming | Treating | Oxide | Covering | | thickness/ | thickness/ | result | |
| No. | method | Solution | species | ratio/% | State of film | μm | μm | Adhesion | Remarks |
| 35 | Liquid phase | (1) | SiO₂ | 100 | — | 5 | 10 | A | Example |
| | deposition | | | | | | | | |
| 36 | Liquid phase | (1) | SiO₂ | 100 | — | 4 | 10 | A | Example |
| | deposition | | | | | | | | |
| 37 | Liquid phase | (1) | SiO₂ | 100 | — | 3 | 10 | A | Example |
| | deposition | | | | | | | | |
| 38 | Liquid phase | (1) | SiO₂ | 100 | — | 2 | 10 | A | Example |
| | deposition | | | | | | | | |
| 39 | Liquid phase | (1) | SiO₂ | 100 | — | 1 | 10 | A | Example |
| | deposition | | | | | | | | |
| 40 | Liquid phase | (1) | SiO₂ | 100 | — | 0.5 | 10 | A | Example |
| | deposition | | | | | | | | |
| 41 | Liquid phase | (2) | TiO₂ | 100 | — | 0.5 | 10 | A | Example |
| | deposition | | | | | | | | |
| 42 | Liquid phase | (2) | TiO₂ | 90 | Crack | 0.5 | 10 | A | Example |
| | deposition | | | | | | | | |
| 43 | Liquid phase | (2) | TiO₂ | 80 | Crack | 0.5 | 10 | A | Example |
| | deposition | | | | | | | | |
| 44 | Liquid phase | (2) | TiO₂ | 70 | Crack | 0.5 | 10 | A | Example |
| | deposition | | | | | | | | |
| 45 | Liquid phase | (2) | TiO₂ | 60 | Island, crack | 0.5 | 10 | A | Example |
| | deposition | | | | | | | | |
| 46 | Liquid phase | (2) | TiO₂ | 50 | Island, crack | 0.5 | 10 | A | Example |
| | deposition | | | | | | | | |
| 47 | Liquid phase | (2) | TiO₂ | 40 | Island, crack | 0.5 | 10 | A | Example |
| | deposition | | | | | | | | |
| 48 | Liquid phase | (2) | TiO₂ | 30 | Island | 0.5 | 10 | A | Example |
| | deposition | | | | | | | | |
| 49 | Liquid phase | (2) | TiO₂ | 20 | Island | 0.5 | 10 | A | Example |
| | deposition | | | | | | | | |
| 50 | Liquid phase | (2) | TiO₂ | 10 | Island | 0.5 | 10 | A | Example |
| | deposition | | | | | | | | |
| 51 | Liquid phase | (3) | ZrO₂ | 70 | Crack | 0.5 | 0.5 | A | Example |
| | deposition | | | | | | | | |
| 52 | Liquid phase | (3) | ZrO₂ | 70 | Crack | 0.5 | 1 | A | Example |
| | deposition | | | | | | | | |
| 53 | Liquid phase | (3) | ZrO₂ | 70 | Crack | 0.5 | 10 | A | Example |
| | deposition | | | | | | | | |
| 54 | Liquid phase | (3) | ZrO₂ | 70 | Crack | 0.5 | 30 | A | Example |
| | deposition | | | | | | | | |
| 55 | Liquid phase | (3) | ZrO₂ | 70 | Crack | 0.5 | 50 | A | Example |
| | deposition | | | | | | | | |
| 56 | Liquid phase | (3) | ZrO₂ | 70 | Crack | 0.5 | 70 | A | Example |
| | deposition | | | | | | | | |
| 57 | Liquid phase | (3) | ZrO₂ | 70 | Crack | 0.5 | 90 | A | Example |
| | deposition | | | | | | | | |
| 58 | Liquid phase | (3) | ZrO₂ | 70 | Crack | 0.5 | 110 | A | Example |
| | deposition | | | | | | | | |
| 59 | Liquid phase | (3) | ZrO₂ | 70 | Crack | 0.5 | 130 | A | Example |
| | deposition | | | | | | | | |
| 60 | Liquid phase | (3) | ZrO₂ | 70 | Crack | 0.5 | 150 | A | Example |
| | deposition | | | | | | | | |
| 61 | Liquid phase | (3) | ZrO₂ | 70 | Crack | 0.5 | 170 | A | Example |
| | deposition | | | | | | | | |
| 62 | Sputtering | — | SiO₂ | 100 | — | 0.5 | 10 | A | Example |
| 63 | Sputtering | — | TiO₂ | 100 | — | 0.5 | 10 | A | Example |
| 64 | Sputtering | — | ZrO₂ | 100 | — | 0.5 | 10 | A | Example |
| 65 | Untreated | —. | —. | — | — | — | 10 | B | Compar- |
| | | | | | | | | | ative |
| | | | | | | | | | example |

Irrespective of the method of forming the covering layer, the stainless steel foils having the covering layer formed exhibited excellent adhesion to the insulating resin layer as compared to the non-treated stainless steel foil.

Further, the samples Nos. 35 to 64 were etched into load beams or flexures to determine the value thereof. As a result, it was confirmed that all samples could be worked while maintaining good precision.

### Example 3

There were used stainless steel foils of 10 μm thick treated under the same conditions as those of No. 10 of Table 1 and having polyimide layers of 10 μm thick. Metal layers were formed on the surfaces of the polyimide resin under the conditions shown in Table 3. The surfaces of the Al foil (No. 71) and the Cu foil (No. 75) having a thickness of 10 μm were treated under the same conditions of forming the oxide layers as those of Nos. 10 and 20 of Table 1, respectively.

The thus obtained samples were tested and evaluated as described above. The results are shown in Table 3.

TABLE 3

| | | | | Insulating | | |
|---|---|---|---|---|---|---|
| | Metal species | | | resin | Evaluation | |
| | or | | | Film | result | |
| | Metal foil | | | thickness/ | Adhesion to | |
| No. | species | Surface treating method of metal foil | Laminating method | μm | metal layer | Remarks |
| 66 | Al | — | Vacuum deposition | 10 | B | Example |
| 67 | Cu | — | Vacuum deposition | 10 | B | Example |
| 68 | Al foil | Untreated | Heat-pressing (same as Example 2) | 10 | B | Example |
| 69 | Al foil | Roughening (shot blast) | Heat-pressing (same as Example 2) | 10 | A | Example |
| 70 | Al foil | Roughening (electrolytic etching) | Heat-pressing (same as Example 2) | 10 | A | Example |
| 71 | Al foil | Liquid phase deposition (TiO₂) | Heat-pressing (same as Example 2) | 10 | A | Example |
| 72 | Cu foil | Untreated | Heat-pressing (same as Example 2) | 10 | B | Example |
| 73 | Cu foil | Roughening (shot blast) | Heat-pressing (same as Example 2) | 10 | A | Example |
| 74 | Cu foil | Roughening (electrolytic etching) | Heat-pressing (same as Example 2) | 10 | A | Example |
| 75 | Cu foil | Liquid phase deposition (ZrO₂) | Heat-pressing (same as Example 2) | 10 | A | Example |

Formation of the laminate was confirmed on all of the samples. Further, the surface-treated metal foils exhibited excellent adhesion to the insulating resin layer.

Further, the sample Nos. 73 to 75 were etched into load beams or flexures to determine the value thereof. As a result, it was confirmed that all samples could be worked while maintaining good precision.

1. A substrate material for an HDD suspension, obtained by shaping a stainless steel foil, wherein, on the surface of said stainless steel foil and on at least one side thereof, there are laminated, at least, a covering layer made chiefly of either one or both of a metal oxide and a metal hydroxide with chromium excluded as the metal species, and an insulating resin layer.

2. A substrate material for an HDD suspension according to claim 1, wherein said covering layer has an average thickness of not larger than 5 μm.

3. A substrate material for an HDD suspension according to claim 1, wherein said covering layer covers the stainless steel foil at a covering ratio of not smaller than 10%.

4. A substrate material for an HDD suspension according to claim 1, wherein said covering layer is distributed like islands on the stainless steel foil.

5. A substrate material for an HDD suspension according to claim 1, wherein cracks are present in said covering layer.

6. A substrate material for an HDD suspension according to claim 1, wherein said metal species is one or more selected from zirconium, titanium and silicon.

7. A substrate material for an HDD suspension according to claim 1, wherein said metal species is titanium.

8. A substrate material for an HDD suspension according to claim 1, wherein the adhering force between the stainless steel foil having said covering layer and the insulating resin layer is not smaller than 0.54 kN/m.

9. A substrate material for an HDD suspension according to claim 1, wherein said stainless steel foil has a thickness of 10 to 100 μm.

10. A substrate material for an HDD suspension according to claim 1, wherein said insulating resin layer has a thickness of 1 to 150 μm.

11. A substrate material for an HDD suspension according to claim 1, wherein said insulating resin layer is a heat-resistant polyimide resin.

12. A substrate material for an HDD suspension according to claim 11, wherein said heat-resistant polyimide resin layer has a three-ply structure of a high thermal expansion polyimide/a low thermal expansion polyimide/a high thermal expansion polyimide.

13. A substrate material for an HDD suspension according to claim 12, wherein said heat-resistant polyimide resin layer has a coefficient of linear expansion in a range of 1×10⁻⁵ to 3×10⁻⁵/° C.

14. A substrate material for an HDD suspension according to claim 1, wherein a metal layer is further laminated on said insulating resin layer.

15. A substrate material for an HDD suspension according to claim 14, wherein said metal layer is a metal foil.

16. A substrate material for an HDD suspension according to claim 15, wherein said metal foil is a surface-treated metal foil.

17. A substrate material for an HDD suspension according to claim 15, wherein said metal foil is a stainless steel foil or a copper foil.

18. A substrate material for an HDD suspension according to claim 14, wherein the adhering force between said metal layer and the insulating resin layer is not smaller than 0.54 kN/m.

19. A substrate material for an HDD suspension according to claim 1, which is a substrate material for a load beam that constitutes the HDD suspension.

20. A substrate material for an HDD suspension according to claim 1, which is a substrate material for a flexure blank that constitutes the HDD suspension.
